(19) United States
(12) Patent Application Publication
(10) Pub. No.: US 2014/0195286 A1
(43) Pub. Date: Jul. 10, 2014

(54) METHODS AND SYSTEMS FOR INTEGRATED CONTROL OF SUBTERRANEAN OPERATIONS

(71) Applicant: Ronald Johannes Dirksen, Spring, TX (US)

(72) Inventor: Ronald Johannes Dirksen, Spring, TX (US)

(21) Appl. No.: 14/113,418

(22) PCT Filed: Aug. 30, 2011
(86) PCT No.: PCT/US11/49703

§ 371 Date: Oct. 23, 2013

(51) Int. Cl. G06Q 10/06

(52) U.S. Cl. CPC G06Q 10/06311
USPC 705/7.13

(57) ABSTRACT

Methods and systems for integrating operations of various subsystems involvement in managing subterranean operations are disclosed. Data relating to a subterranean operation is received from one or more functional units at a centralized functional unit. The received data is used by the centralized functional unit to in a number of ways including communicating with a procurement subsystem to coordinate availability of materials for an upcoming subterranean operation; communicating with a operations support subsystem to at least one of coordinate availability of personnel to perform one or more subterranean operations and perform quality control on one or more subterranean operations; and communicating with a logistics subsystem to manage mobilization of personnel to perform one or more subterranean operations.

### BACKGROUND

Hydrocarbons, such as oil and gas, are commonly obtained from subterranean formations. The development of subterranean operations and the processes involved in removing hydrocarbon from the subterranean formation are complex. Typically, subterranean operations involve a number of different steps such as, for example, drilling the wellbore at a desired well site, treating the wellbore to optimize production of hydrocarbons, and performing the necessary steps to produce and process the hydrocarbons from the subterranean formation.

The performance of various phases of subterranean operations involves numerous tasks that are typically performed by different subsystems located at the well site, or positioned remotely therefrom. For instance, at each stage, it is important to ensure the availability of required materials for the performance of different steps of subterranean operations. Moreover, at each step, it is important to ensure that personnel having suitable training are available. Further, it is important to remain cognizant of various environmental and safety requirements when performing the different steps of subterranean operations at a well site. These and other considerations give rise to a number of logistical considerations when performing subterranean operations.

The demand for hydrocarbons such as oil and gas is on the rise. With the increasing demand for hydrocarbons and the desire to minimize the costs associated with performing subterranean operations, the efficient performance of subterranean operations is of great importance. However, currently, the performance of subterranean operations is not optimal due to lack of integration of various subsystems.

### BRIEF DESCRIPTION OF THE DRAWINGS

FIG. 1 shows a subterranean operation management system in accordance with an exemplary embodiment of the present invention;

FIG. 2 shows an integrated control system in accordance with an exemplary embodiment of the present invention;

FIG. 3 shows a centralized functional unit in accordance with an exemplary embodiment of the present invention;

FIG. 4 depicts an exemplary implementation of performing a quality check using the data quality control component of FIG. 3.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present invention, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like. Devices and methods in accordance with certain embodiments may be used in one or more of wireline, measurement-while-drilling (MWD) and logging-while-drilling (LWD) operations. “Measurement-while-drilling” is the term generally used for measuring conditions downhole concerning the movement and location of the drilling assembly while the drilling continues. “Logging-while-drilling” is the term generally used for similar techniques that concentrate more on formation parameter measurement.

The terms “couple” or “couples,” as used herein are intended to mean either an indirect or direct connection. Thus, if a first device couples to a second device, that connection may be through a direct connection, or through an indirect electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

The present application is directed to improving efficiency of subterranean operations and more specifically, to a method and system for integrating operations of various subsystems involvement in managing subterranean operations.

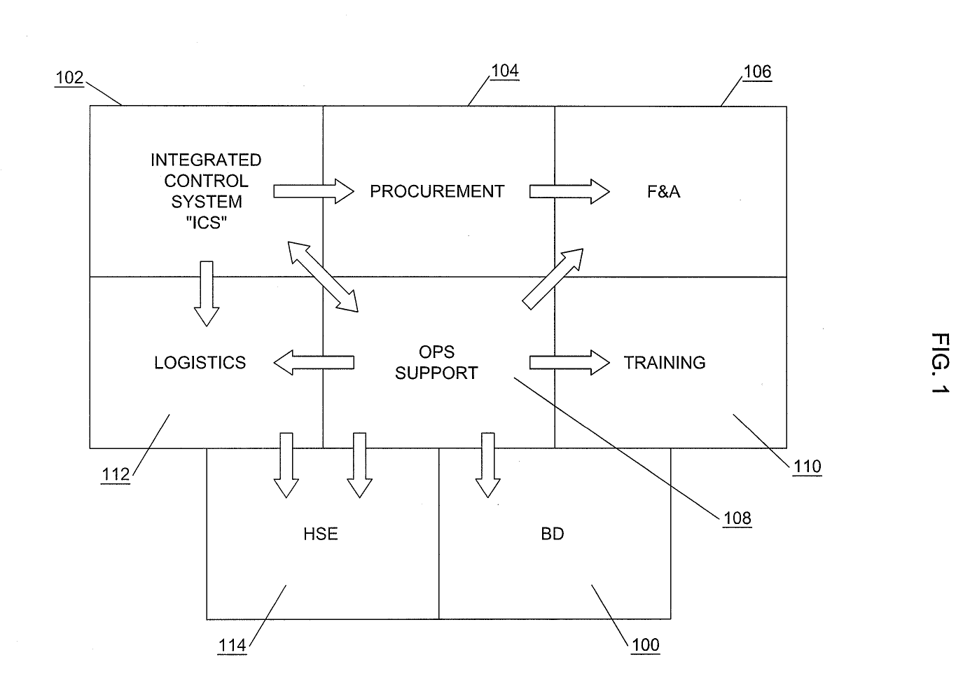

Turning to FIG. 1, a subterranean operation management system (“SOMS”) in accordance with an exemplary embodiment of the present invention is denoted generally with reference numeral 100. The SOMS may include an Integrated Control System (“ICS”) 102. The ICS 102 may include a centralized functional unit (“CFU”) that is operational to receive data from various sensors and components of the SOMS 100 and monitor the operation of the different subsystems involved in the subterranean operation.

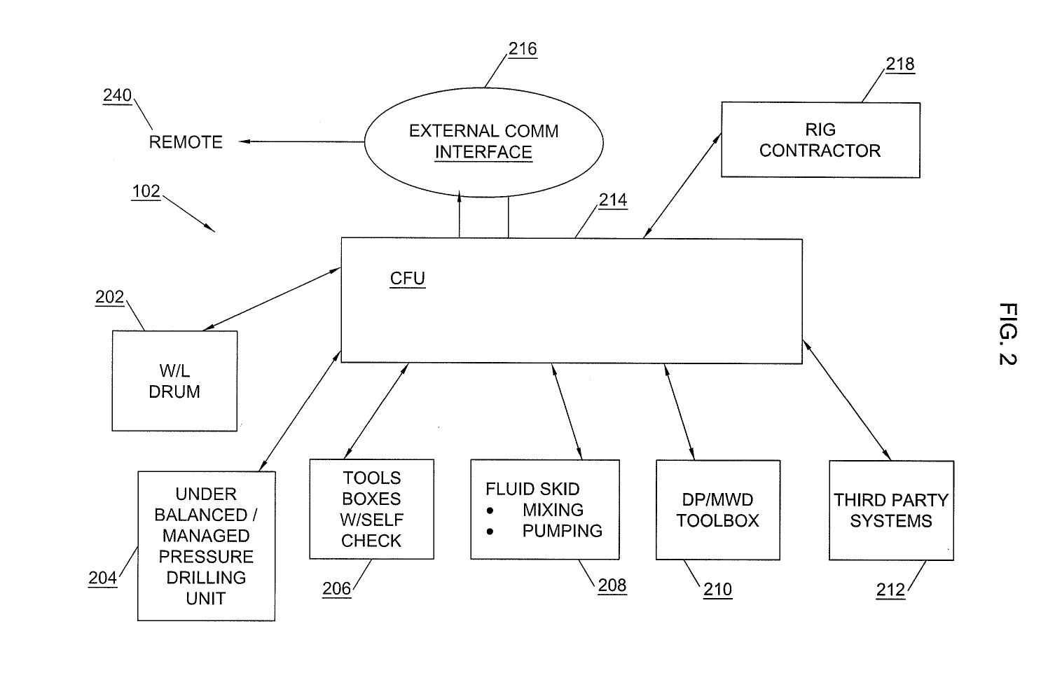

FIG. 2 shows an example embodiment of implementing a centralizing monitoring system using a CFU. The system may contain one or more functional units at the rig site that require monitoring. The functional units may include one or more of a wireline drum 202, underbalanced/managed pressure drilling unit 204, tool boxes containing self-check 206, fluid skid 208, including mixing and pumping units, and measurement while drilling toolbox 210. The functional units may also include third party functional units 212.

Each functional unit may be communicatively coupled to the CFU 214. In one embodiment, the CFU 214 may be a Central Data Acquisition System. In certain embodiments, the connection may be an Ethernet connection via an Ethernet cord. As would be appreciated by those of ordinary skill in the art, with the benefit of this disclosure, the functional units may be communicatively coupled to the CFU 214 by other suitable connections, such as, for example, wireless, radio, microwave, or satellite communications. Such connections are well known to those of ordinary skill in the art and will therefore not be discussed in detail herein. In one exemplary embodiment, the functional units could communicate bidirectionally with the CFU 214. In another embodiment, the functional units could communicate directly with other functional units employed at the rig-site.

In one exemplary embodiment, communication between the functional units may be by a common communication protocol, such as the Ethernet protocol. For functional units that do not communicate in the common protocol, a converter may be implemented to convert the protocol into a common protocol used to communicate between the functional units. With a converting unit, a third party such as a Rig Contractor 218, may have their own proprietary system communicating to the CFU 214.

In one embodiment, the functional units may record data in such a manner that the CFU 214 using software can track and monitor all of the functional units. The data will be stored in a database with a common architecture, such as, for example, oracle, SQL, or other type of common architecture.

The operations will occur in real-time and the data acquisition from the various functional units need to exist. In one embodiment of data acquisition at a centralized location, the data is pushed at or near real-time enabling real-time communication, monitoring, and reporting capability. This allows the collected data to be used in a streamline workflow in a real-time manner by other systems and operators concurrently with acquisition.

As shown in FIG. 2, in one exemplary embodiment, the CFU 214 may be communicatively coupled to an external communication interface 216. The external communications interface 216 permits the data from the CFU 214 to be remotely accessible by any remote information handling system 240 via, for example, a satellite, a modem or wireless connections. In one embodiment, the external communication interface 216 may include a router.

In accordance with an exemplary embodiment of the present invention, once feeds from one or more functional units are obtained, they may be combined and used to monitor the system and/or identify various metrics. For instance, if there is data that deviates from normal expectancy at the rig site, the combined system may show another reading of the data from another functional unit that may help identify the type of deviation. For instance, if a directional sensor is providing odd readings, but another sensor indicates that the fluid is being pumped nearby, that would provide a quality check and an explanation for the deviation. As would be appreciated by those of ordinary skill in the art, with the benefit of this disclosure, a CFU 214 may also collect data from multiple rig-sites and wells to perform quality check across a plurality of rig-sites.

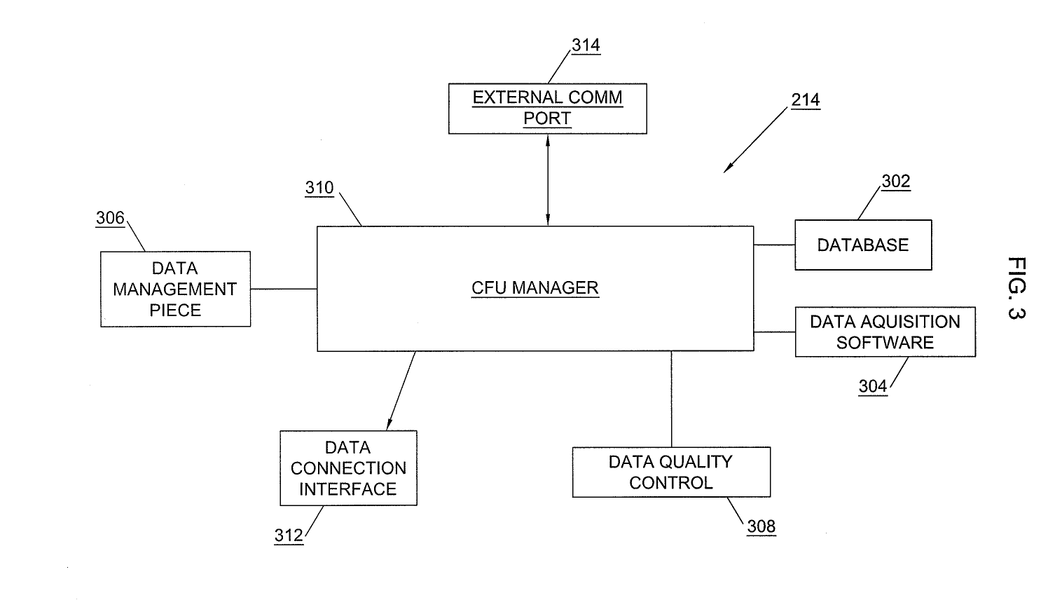

FIG. 3 depicts a CFU 214 in accordance with an exemplary embodiment of the present invention. The CFU 214 may collect, store, and report data from a variety of functional units as discussed above with reference to FIG. 2. In one embodiment, the CFU 214 may include a database 302 which may, for example, store the data collected from one or more functional units. As would be appreciated by those of ordinary skill in the art, with the benefit of this disclosure, the database 302 may include a computer-readable media. In one embodiment, the CFU 214 may also include a data acquisition software 304 for performing, for example, the collection and reporting functions. In one exemplary embodiment, the data acquisition software 304 may offer visualization of the various sensors and tools dynamically and/or in real-time. Users of the system, such as subject matter experts, could then be able to access the information provided by the data acquisition software 304 remotely and use it to analyze system performance and make operational decisions.

In one exemplary embodiment, the CFU 214 may further include a data management component 306. In one embodiment, the data management component 306 may also include security software. As would be appreciated by those of ordinary skill in the art, with the benefit of this disclosure, the security software may regulate access to system information by containing user accounts, administrative accounts and other tools that may be used to regulate data management. Further, the data management component 306 may include a centralized audit trail system that may provide a common reporting structure and system. In one embodiment, the data management component 306 may further provide reporting and standardization of deliverables.

As would be appreciated by those of ordinary skill in the art, with the benefit of this disclosure, the CFU 214 may be implemented on virtually any type of information handling system regardless of the platform being used. Moreover, one or more elements of the information handling system may be located at a remote location and connected to the other elements over a network. In a further embodiment, the information handling system may be implemented on a distributed system having a plurality of nodes. Such distributed computing systems are well known to those of ordinary skill in the art and will therefore not be discussed in detail herein.

As shown in FIG. 3, the CFU 214 may further include a data quality control component 308 for monitoring the quality of data acquired from the different functional units. In one exemplary embodiment, the data quality control component 308 may notify an operator when a particular sensor fails to provide data that meets preset quality standards.

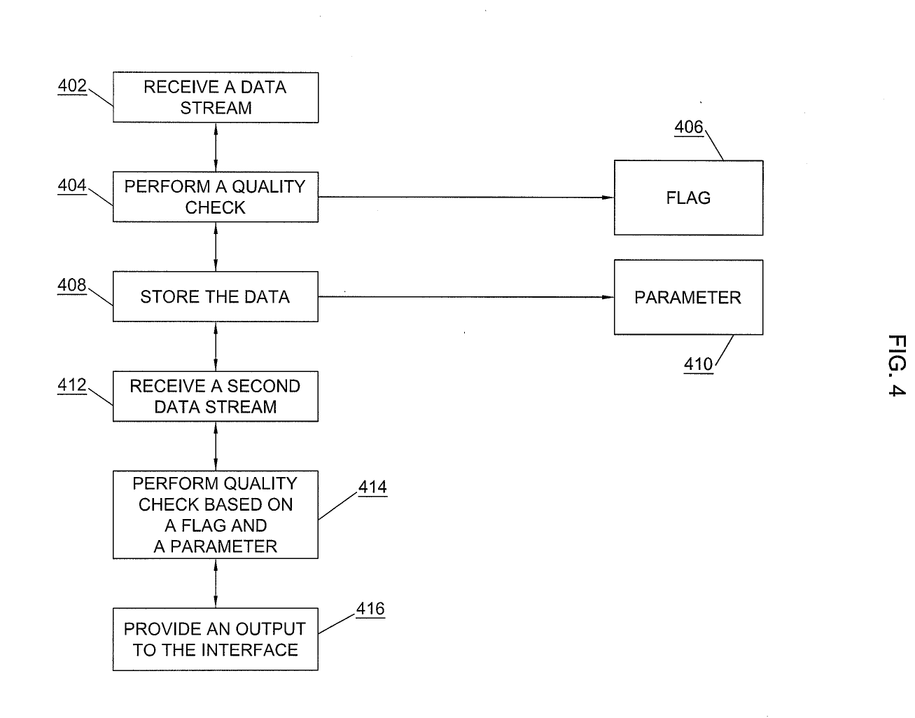

FIG. 4 depicts an exemplary implementation of performing a quality check using the data quality control component 308. At step 402, first data stream is received from a functional unit. Depending on the flag status 404, a quality check is performed on the data at step 406. The data is then stored at step 408 based on a parameter setting 410. A second data stream is then received from the functional unit at step 412. At step 414 a quality check is performed on the second data stream using the flag status 404 and the parameter setting 410. Finally at step 412 an output may be provided such as, for example, a visual indication for action or an automated action for a device. Information obtained from a rig-site may also serve as a quality check measurement in future rig-site developments.

Returning to FIG. 3, a CFU manager 310 may be communicatively coupled to one or more functional units through the data connection interface 312. The CFU manager 310 may control and/or coordinate the operations of the various CFU 214 components as shown in FIG. 3. Additionally, the CFU manager 310 may communicate with the external communication interface 216 through the external communication port 314.

The centralized collection and storage of data may also be available for other jobs to perform quality check of integrated data. Additional software may also provide for pattern recognition and case based reasoning based on models developed based on the centralized collection of data. Specifically, the collection of data over a set period may be used to predict future system performance and requirements.

Returning now to FIG. 1, once data regarding well site operations is obtained by the ICS 102, the ICS 102 may optimize well site operations by controlling the different subsystems involved. The ICS 102 may be communicatively coupled to the different subsystems through wired or wireless communication systems. As discussed above, such systems are well known to those of ordinary skill in the art and will therefore not be discussed in detail herein.

In on embodiment, the ICS 102 may be communicatively coupled to the procurement subsystem 104. As discussed above with reference to FIGS. 2-4, the ICS 102 may obtain data through the CFU from the different functional units at the well site. Using that data, the ICS 102 may determine the need for additional materials or may forecast future need of a system component for a particular material at the well site. In one embodiment, the ICS 102 may receive information regarding, for example, the materials needed by a particular functional unit, when the materials will be needed, and the amount of particular materials needed from the functional units. In another exemplary embodiment, the ICS 102 may identify the particular operation taking place at the well site (e.g. drilling) and use that in conjunction with data previously provided to the ICS 102 by the operator to identify the type and amount of the materials required to perform that operation.

In another exemplary embodiment the ICS 102 may use the data obtained from the functional units to identify the processes currently being performed at a particular website. Using that information together with information previously provided to the ICS 102 by the operator regarding the order of subterranean operations, the ICS 102 may use the data obtained from the functional units to identify upcoming operations. Once the next operation to be performed is identified, the ICS 102 may determine the materials needed and the amount of the different materials required to satisfy a particular job.

In another exemplary embodiment, the ICS 102 may periodically poll the procurement subsystem 104 to determine how much of a particular material is available in the inventory. This application is particularly useful with respect to materials which are used in a number of different subterranean operations and/or are otherwise consistently required at the well site.

One information such as, for example, the type and amount of materials required has been identified by the ICS 102, the ICS 102 may communicate this information to the procurement subsystem 104. Once the procurement subsystem 104 receives an inquiry for a particular material from the ICS 102, it may check the inventor to determine if there is a sufficient amount of the required material in the inventory to satisfy the job requirements.

In each of the above exemplary embodiments, if it is determined that the amount of a requisite material is insufficient to meet the requirements of the subterranean operations, an inventory flag may be set for that material by the ICS 102. In one embodiment, a threshold value for the amount of materials may be identified and used to determine the “sufficiency” of that material. The threshold value(s) may be provided as an input to the ICS 102. In this embodiment, the ICS 102 may monitor the system to ensure that the amount of the particular material does not fall below the preset threshold value. Accordingly, an inventor flag may be set by the ICS 102 if it is determined that the amount of a material has fallen below the preset threshold value.

Once an inventory flag is set, the procurement subsystem 104 may be notified. In one embodiment, the ICS 102 may also notify the procurement subsystem 104 of the amount of the particular material required. In response, the procurement subsystem 104 may order the required amount of that material from a vendor or from a storage location. In one embodiment, the ICS 102 may further use the data obtained from the functional units to identify where at the well site the particular material is required. The information may then be passed on by the procurement system 104 to ensure that the right amount of the desired material is delivered to the correct location at the well site. In one exemplary embodiment, the ICS 102 may also communicate a deadline for the delivery of particular materials to the procurement subsystem 104 and the procurement subsystem 104 may include that information when placing an order with a vendor or requesting delivery from storage. Once the required amount of the particular material has been delivered, the procurement subsystem 104 may be notified. The procurement subsystem 104 may then notify the ICS 102 of the same and the inventory flag relating to the delivered material may be reset to indicate that the supply of that material has been replenished.

In one exemplary embodiment, the procurement subsystem 104 may inform the ICS 102 once an order has been placed and the ICS 102 may store that information and/or provide that information to the operator through a user interface.

In one exemplary embodiment, the procurement subsystem 104 may be communicatively coupled to the Facilities and Administrative (“F&A”) subsystem 106. In one exemplary embodiment, the information communicated by the procurement subsystem 104 to the F&A subsystem 106 may include, for example, the material ordered, the amount of material ordered, and/or the identity of the vendor supplying the material. In one exemplary embodiment, vendor information, such as, for example, identity of the vendor, price of different materials offered by different vendors, the payment terms negotiated with the different vendors, and or the agreed upon method of payment for the different vendors may be provided to the F&A subsystem 106. Accordingly, the F&A subsystem 106 may use the information received from the procurement subsystem 104 to process payment for the order(s) placed by the procurement subsystem 104.

In one exemplary embodiment, once payment has been made for a particular material the F&A subsystem 106 may inform the ICS 102 accordingly. The ICS 102 may then store that information and use and/or provide that information to the operator through a user interface, thereby providing a real-time evaluation of the expenses incurred for a particular subterranean operation or a portion thereof. In another exemplary embodiment, the ICS 102 may periodically poll the F&A subsystem for processed payments and store that information in computer readable media or display that information in real-time through a user interface. Similarly, the ICS 102 may periodically poll the procurement subsystem 104 for orders placed and store or display that information in real time.

In one exemplary embodiment, the data obtained from the functional units by the CFU 214 of the ICS 102 may be used to identify the particular well site operation being performed in real-time. As discussed above, once the ICS 102 determines which operation is being performed, it may use that information to forecast the upcoming operations. Further, in one embodiment, the ICS 102 may also determine at what point in time each of the upcoming operations will likely be initiated. The ICS 102 may use this information in a number of ways.

In one exemplary embodiment, the ICS 102 may be communicatively coupled to the Operations Support (“OPS Support”) subsystem 108. The OPS Support subsystem may coordinate the availability of personnel to perform subterranean operations. Once the upcoming operations are identified the ICS 102 may communicate with the Operations Support (“OPS Support”) subsystem 108. The OPS Support subsystem 108 may use that information to brief personnel on the next phase of operations.

In one exemplary embodiment, once the ICS 102 identifies the upcoming operation(s), it determines whether the upcoming operation(s) require any particular personnel training For instance, in one exemplary embodiment, the ICS 102 database 302 may include a list of the names and expertise of the personnel present at the well site. The ICS 102 may then use that information to determine if the personnel available have the necessary expertise required for performing upcoming operations. If the ICS 102 determines that the existing personnel lack the necessary expertise to perform the upcoming operations or would otherwise benefit from a training session, it may notify OPS Support subsystem 108. The OPS Support subsystem 108 may then communicate that information to the Training subsystem 110.

In one exemplary embodiment the notification generated by the ICS 102 to the OPS Support subsystem 108 and the Training subsystem 110 may include information, such as, for example, the identity of the upcoming operation necessitating the training, the training required, when the upcoming operation needs to be initiated, and the number of field personnel that need to attend the training session. The OPS Support subsystem 108 may use that information to identify the necessary training that should be provided within the desired timeframe.

As would be appreciated by those of ordinary skill in the art, with the benefit of this disclosure, the necessary training may be provided to the personnel remotely or an individual may provide the training at the well site. The Training subsystem 110 may coordinate that training When a remote training session is to be held, the training subsystem 110 may coordinate the training session and OPS Support subsystem 108 may communicate the details of the training session to the ICS 102. The ICS 102 may then identify the personnel that need to participate in the training session and communicate the details of the training session to them. If an individual is to provide the training at the well site, the OPS Support subsystem 108 may communicate the details of the training session, such as the date and location of the session and the trainer name to the logistics subsystem 112. The operation of the logistics subsystem is discussed in more detail below. Further, to the extent the performance of the training session or other preparations for upcoming operations requires assistance from outside vendors or contractors, the OPS Support subsystem 108 may communicate that information to the F&A Subsystem 106 to ensure the necessary accounting activities are handled.

In one embodiment, the OPS Support subsystem 108 may use the information obtained by the CFU 214 of the ICS 102 to perform quality control to ensure that the various processes being performed and the materials used meet the standards set by the operator. In one embodiment, a determination by the OPS Support subsystem 108 that a process and/or material fails to meet preset standards may trigger a notification by the OPS Support subsystem 108 to the ICS 102. The ICS 102 may then store and/or display that information in real-time to the operator who can then handle any issues in a timely manner.

In one exemplary embodiment, the OPS Support subsystem 108 may be communicatively coupled to a Health, Safety and Environment (“HAS”) subsystem 114 which monitors and/or analyzes environment impact of subterranean operations. The HSE subsystem may include information regarding various environment and safety standards applicable to the operations being performed at the well site. The ICS 102 may communicate the information obtained from the various functional units through the CFU 214 to the HSE subsystem 114. The HSE subsystem 114 may process that information and determine if the operations are in compliance with predetermined health and safety standards. In one exemplary embodiment, the HSE subsystem 114 may communicate a failure to comply with health and safety standards to the ICS which may store and/or display that information. The notifications issued by the ICS may be used to modify or halt ongoing operations to ensure compliance. In another exemplary embodiment, the HSE subsystem 114 may directly notify the operator of failures to comply with the health and safety standards.

In one exemplary embodiment, the HSE subsystem 114 may also facilitate upcoming subterranean operations by briefing the personnel about the health and safety regulations application to the particular operation. Additionally, the HSE subsystem 114 may coordinate the operations of the Property Plant & Equipment (“PP&E”) to ensure compliance with health, safety and environmental regulations.

In one embodiment, the OPS Support subsystem 108 may be communicatively coupled to the Business Development subsystem (“BD subsystem”) 116. In one embodiment, the BD subsystem may facilitate an interface for customers to monitor the operations being performed at the well site, the expenses incurred for the operations, the personnel and materials being utilized as well as upcoming operations and expenses. As discussed in detail above, this information is available through the ICS 102. In another exemplary embodiment, the BD subsystem 116 may plan the next operation once current operations near completion. Specifically, the BD subsystem may interface with the customers informing them of status of the operations and/or the nature of upcoming operations. This information may be used to facilitate coordination between the operator of subterranean operations and the well site owner.

In another exemplary embodiment, once the ICS 102 forecasts the upcoming subterranean operations to be performed at the well site, it may identify the personnel required. In one embodiment, the ICS 102 database 302 may include information about the personnel at the well site and/or available contractors and their qualifications and expertise. That information may be used by the ICS 102 to identify the personnel best suited for carrying out aspects of a subterranean operation at the well site. Once the ICS 102 identifies the personnel and/or contractors required for a particular upcoming operation, it may communicate that information to the logistics subsystem 112. In one embodiment, the ICS 102 may communicate the date and location where particular personnel and/or contractors are required to support a subterranean operation at a well site.

In one embodiment, the logistics subsystem 112 may be used to mobilize/demobilize resources and personnel. For instance, the logistics subsystem 112 may receive information regarding the individuals required at a well site, such as trainers, personnel, and/or contractors from the ICS 102, the OPS Support subsystem 108 and/or the training subsystem 110. The logistics subsystem 112 may then perform one or more actions to coordinate the upcoming operations. In one embodiment, the logistics subsystem 112 may inform the personnel, trainer(s) and/or contractor(s) when/where they should report. In another exemplary embodiment, the logistics subsystem 112 may make travel arrangements to ensure that the right people report to the well site at the right time. For instance, the logistics subsystem 112 may provide hotel reservations, airline reservations, and/or car rental for the individuals that are to be come to the well site. In one exemplary embodiment, the logistics subsystem 112 may inform the ICS 102 once the necessary arrangements are made and the ICS 102 may store and/or display that information. In one exemplary embodiment, the logistics subsystem 112 may also notify the personnel, trainer(s) and or contractor(s) if the travel arrangements. In another exemplary embodiment, the logistics subsystem 112 may communicate with the F&A subsystem 106 to handle the necessary accounting for performing the logistics functions.

In one exemplary embodiment, the logistics subsystem may be communicatively coupled to the procurement subsystem 104 to manage the delivery of materials to the well site.

As would be appreciated by those of ordinary skill in the art, with the benefit of this disclosure, although certain components are depicted as being part of the SOMS, these components are used for illustrative purposes. Accordingly, additional components may be used in conjunction with the methods and systems disclosed herein. Alternatively, one or more subsystems may be eliminated without departing from the scope of the present disclosure.

As would be appreciated by those of ordinary skill in the art, with the benefit of this disclosure, the methods and systems disclosed herein may be used in conjunction with oil wells, natural gas wells, hydrocarbon wells as well as mineral extraction operations in general. Further, such wells can be used for production, monitoring, or injection in relation to the recovery of hydrocarbons or other materials from the subsurface.

Further, as would be appreciated by those of ordinary skill in the art, with the benefit of this disclosure, one or more of the subsystems disclosed herein may be combined to provide further system integration. For instance, in one exemplary embodiment, the F&A subsystem 106 may be integrated with the procurement subsystem 104. Moreover, as would be appreciated by those of ordinary skill in the art, with the benefit of this disclosure, at each point during subterranean operations, the various subsystems may keep the ICS 102 apprised of the status of various operations. For instance, in one embodiment, the training subsystem 110 may inform the ICS 102 that it has identified a particular trainer and submitted the information regarding that trainer to the logistics subsystem 112.

The present invention is therefore well-adapted to carry out the objects and attain the ends mentioned, as well as those that are inherent therein. While the invention has been depicted, described and is defined by references to examples of the invention, such a reference does not imply a limitation on the invention, and no such limitation is to be inferred. The invention is capable of considerable modification, alteration and equivalents in form and function, as will occur to those ordinarily skilled in the art having the benefit of this disclosure. The depicted and described examples are not exhaustive of the invention. Consequently, the invention is intended to be limited only by the spirit and scope of the appended claims, giving full cognizance to equivalents in all respects.

1. An integrated system for performance of subterranean operations comprising:
an integrated control system;
wherein the integrated control system monitors one or more subterranean operations;
wherein the integrated control system comprises a centralized functional unit communicatively coupled to one or more functional units;
wherein the centralized functional unit comprises an information handling system;
a procurement subsystem communicatively coupled to the information handling system;
wherein the procurement subsystem and the information handling system communicate to ensure availability of required materials at the one or more functional units;
an operations support subsystem communicatively coupled to the information handling system,
wherein the operations support subsystem at least one of coordinates availability of personnel to perform subterranean operations and performs quality control on subterranean operations;
a logistics subsystem communicatively coupled to at least one of the information handling system and the operations support subsystem, wherein the logistics subsystem manages mobilization of personnel for the one or more subterranean operations.

2. The system of claim 1, wherein the one or more functional units are selected from the group consisting of a Wireline drum, an underbalanced/managed pressure drilling unit, a tool boxes containing self-check, a fluid skid, and a measurement while drilling toolbox.

3. The system of claim 1, wherein the one or more functional units communicate with the information handling system through a common communication protocol.

4. The system of claim 1, wherein the centralized functional unit is communicatively coupled to a remote information handling system.

5. The system of claim 1, wherein the information handling system processes information received from the one or more functional units, and wherein the information handling system uses the processed information to monitor the subterranean operations.

6. The system of claim 1, wherein the information handling system at least one of collects, stores, and reports data received from the one or more functional units.

7. The system of claim 1, wherein the centralized functional unit comprises at least one of a data management component, a data connection interface, a data quality control component, and a database.

8. The system of claim 1, wherein the procurement subsystem procures materials required at one or more functional units, further comprising a facilities and administrative subsystem communicatively coupled to at least one of the procurement subsystem and the integrated control system, wherein the facilities and administrative subsystem processes payments for orders placed by the procurement subsystem.

9. The system of claim 1, further comprising a training subsystem communicatively coupled to at least one of the integrated control system and the operations support subsystem, wherein the training subsystem coordinates training of personnel for subterranean operations.

10. A method of integrating subterranean operations comprising:
receiving data relating to a subterranean operation from one or more functional units at a centralized functional unit comprising an information handling system;
using the data received by the information handling system to at least one of:
communicate with a procurement subsystem to coordinate availability of materials for an upcoming subterranean operation;
communicate with a operations support subsystem to at least one of coordinate availability of personnel to perform one or more subterranean operations and perform quality control on one or more subterranean operations; and
communicate with a logistics subsystem to manage mobilization of personnel to perform one or more subterranean operations.

11. The method of claim 10, wherein the centralized functional unit comprises at least one of a data management component, a data connection interface, a data quality control component, and a database.

12. The method of claim 10, wherein the one or more functional units are selected from the group consisting of a Wireline drum, an underbalanced/managed pressure drilling unit, a tool boxes containing self-check, a fluid skid, and a measurement while drilling toolbox.

13. The method of claim 10, further comprising communicatively coupling the centralized functional unit to a remote information handling system.

14. The method of claim 10, further comprising processing the data received from the one or more functional units at the information handling system and using the processed data to monitor the subterranean operations.

15. The method of claim 10, wherein coordinating availability of materials for an upcoming subterranean operation comprises communicatively coupling at least one of the information handling system and the procurement subsystem to a facilities and administrative subsystem, wherein the facilities and administrative subsystem processes payments for orders placed by the procurement subsystem.

16. The method of claim 10, further comprising communicatively coupling at least one of the information handling system and the operations support subsystem to a training subsystem, wherein the training subsystem coordinates training of personnel for subterranean operations.

17. An integrated subterranean operation control system comprising:
an integrated control system communicatively coupled to at least one of a procurement subsytem, an operations support subsystem and a logistics subsystem;
wherein the integrated control system comprises a centralized functional unit communicatively coupled to one or more functional units;
wherein the centralized functional unit comprises an information handling system;
wherein the procurement subsystem and the information handling system communicate to ensure availability of required materials at the one or more functional units;
wherein the operations support subsystem at least one of coordinates availability of personnel to perform subterranean operations and performs quality control on subterranean operations;
wherein the logistics subsystem manages mobilization of personnel for the one or more subterranean operations.

18. The system of claim 17, further comprising at least one of:
a facilities and administrative subsystem communicatively coupled to at least one of the procurement subsystem and the information handling system, wherein the facilities and administrative subsystem processes payments for orders placed by the procurement subsystem;
a training subsystem communicatively coupled to at least one of the information handling system and the operations support subsystem, wherein the training subsystem coordinates training of personnel for subterranean operations;
a business development subsystem communicative coupled to at least one of the operations support subsystem and the information handling system, wherein the business development subsystem interfaces with a customer; and
a health, safety and environment subsystem communicatively coupled to at least one of the information handling system, the logistics subsystem and the operations support subsystem, wherein the health, safety and environment subsystem to at least one of monitor and analyze environmental impact of subterranean operations.

19. The system of claim 17, wherein the one or more functional units communicate with the information handling system through a common communication protocol.

20. The system of claim 17, wherein the centralized functional unit comprises at least one of a data management component, a data connection interface, a data quality control component, and a database.
